(19) United States
(12) Patent Application Publication
(10) Pub. No.: US 2026/0331014 A1
(43) Pub. Date: Oct. 22, 2026

(54) DRIVER CIRCUIT

(71) Applicant: NOVATEK Microelectronics Corp., Hsinchu (TW)

(72) Inventor: Yu-Shao LIU, Kaohsiung City (TW)

(21) Appl. No.: 19/183,915

(22) Filed: Apr. 20, 2025

(51) Int. Cl. G09G 3/20

(52) U.S. Cl. CPC G09G 3/20; G09G 2320/0673; G09G 2330/028

(57) ABSTRACT

A gamma voltage generation circuit is provided and includes a programmable voltage generation unit to generate gamma voltages in response to voltage configuration data; a control circuit to refresh the voltage configuration data in response to voltage command data to control the programmable voltage generation unit; and a detection circuit to detect the voltage configuration data or voltage signals, corresponding to the gamma voltages, of the programmable voltage generation unit to adjust the gamma voltages.

### BACKGROUND

### Field of Invention

The present invention relates to a driver circuit including a gamma voltage generation circuit. More particularly, the present invention relates to the gamma voltage generation circuit utilizing protection and feedback schemes.

### Description of Related Art

The driver integrated circuit (IC) including a programmable gamma voltage generation circuit (PGMA) circuit is widely used for driving display panels. However, incorrect settings or unexpected events such as electrostatic discharge (ESD) happened to the circuitry leads vulnerability of the IC. Consequently, the device was susceptible to failure under various operating conditions.

### SUMMARY

A driver circuit including a gamma voltage generation circuit is provided. The gamma voltage generation circuit includes a programmable voltage generation unit to generate gamma voltages in response to voltage configuration data; a control circuit to refresh the voltage configuration data in response to voltage command data to control the programmable voltage generation unit; and a detection circuit to detect the voltage configuration data or voltage signals, corresponding to the gamma voltages, of the programmable voltage generation unit to adjust the gamma voltages.

According to another embodiment, a driver circuit including a gamma voltage generation circuit is provided. The gamma voltage generation circuit includes a programmable voltage generation unit including digital-to-analog converters (DACs) to generate signals in response to voltage configuration data, and further including amplifiers each coupled to a corresponding DAC of the DACs and configured to output a corresponding gamma voltage in response to the corresponding signal; a control circuit to refresh the voltage configuration data in response to voltage command data to control the programmable voltage generation unit; and a detection circuit configured to detect characteristics of the programmable voltage generation unit to generate detection data to the control circuit for adjusting the gamma voltages.

According to another embodiment, a gamma voltage generation circuit is provided. The gamma voltage generation circuit includes a programmable voltage generation unit including digital-to-analog converters (DACs) and amplifiers, in which an output of one of the DACs is coupled to an input of a corresponding one of the amplifiers; multiple clamping units each coupled between two adjacent DACs to clamp a voltage difference between outputs of the two adjacent DACs; and a control circuit to refresh voltage configuration data of the DACs in response to voltage command data to control the programmable voltage generation unit to output gamma voltage through the amplifiers.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 is schematic diagram of a driver circuit, in accordance with some embodiments.

FIG. 2 is schematic diagram of a programmable voltage generation unit, in accordance with some embodiments.

FIG. 3 is schematic diagram of part of a gamma voltage generation circuit corresponding to FIG. 1, in accordance with some embodiments.

FIG. 4A is schematic diagram of a detection circuit, in accordance with some embodiments.

FIG. 4B is a flowchart of a method of operating the gamma voltage generation circuit corresponding to FIG. 3 and 4A, in accordance with some embodiments.

FIG. 5A is schematic diagram of a detection circuit, in accordance with some embodiments.

FIG. 5B is a flowchart of a method of operating the gamma voltage generation circuit corresponding to FIG. 3 and 4A, in accordance with some embodiments.

FIG. 6 is schematic diagram of part of a gamma voltage generation circuit corresponding to FIG. 1, in accordance with some embodiments.

FIG. 7A is schematic diagram of part of a gamma voltage generation circuit corresponding to FIG. 6, in accordance with some embodiments.

FIG. 7B is schematic diagram of part of a gamma voltage generation circuit corresponding to FIG. 6, in accordance with some embodiments.

FIG. 8A is schematic diagram of part of a gamma voltage generation circuit corresponding to FIG. 6, in accordance with some embodiments.

FIG. 8B is schematic diagram of part of a gamma voltage generation circuit corresponding to FIG. 6, in accordance with some embodiments.

FIG. 9 is schematic diagram of part of a gamma voltage generation circuit corresponding to FIG. 6, in accordance with some embodiments.

FIG. 10 is schematic diagram of part of a gamma voltage generation circuit corresponding to FIG. 6, in accordance with some embodiments.

FIG. 11 is schematic diagram of part of a gamma voltage generation circuit corresponding to FIG. 1, in accordance with some embodiments.

FIG. 12 is schematic diagram of part of a gamma voltage generation circuit corresponding to FIG. 11, in accordance with some embodiments.

FIG. 13 is schematic diagram of part of a gamma voltage generation circuit corresponding to FIG. 11, in accordance with some embodiments.

FIG. 14 is schematic diagram of part of a gamma voltage generation circuit corresponding to FIG. 11, in accordance with some embodiments.

FIG. 15 is schematic diagram of part of a gamma voltage generation circuit corresponding to FIG. 1, in accordance with some embodiments.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

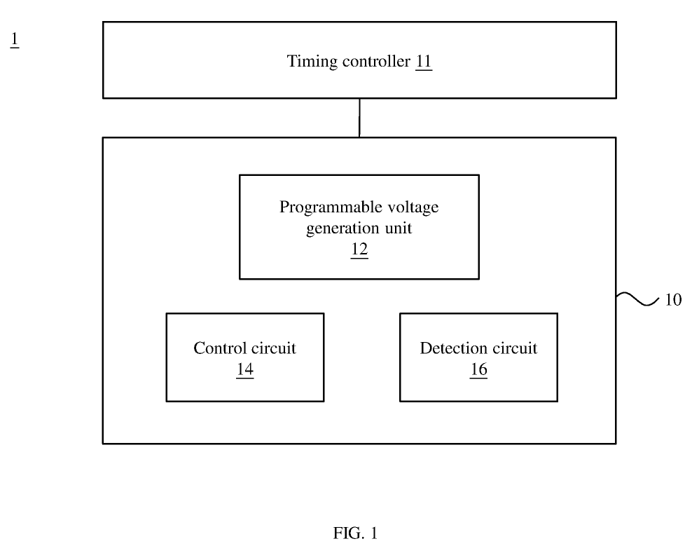

Reference is now made to FIG. 1. FIG. 1 is schematic diagram of a driver circuit 1, in accordance with some embodiments. As shown in FIG. 1, the driver circuit 1 includes a timing controller 11 and a gamma voltage generation circuit 10 coupled to the timing controller 11. In some embodiments, the driver circuit 1 is configured to drive a display panel (not shown) through providing at least according to pixel data and gamma reference voltages. In the embodiments of FIG. 1, the timing controller 11 controls the gamma voltage generation circuit 10 by transmitting voltage command data via a data bus or a control bus, which provides different gamma curves according to the different characteristics in all (or partial) regions of the display panel. In some embodiments, the control circuit 14 can be a microcontroller (MCU) or other suitable logic control circuit.

In FIG. 1, the gamma voltage generation circuit 10 includes a programmable voltage generation unit 12, a control circuit 14, and a detection circuit. In some embodiments, the programmable voltage generation unit 12 is configured to generating gamma voltages in response to voltage configuration data provided by the control circuit 14. In some embodiments, the voltage configuration data may be gamma configuration data.

The control circuit 14 is configured to provide and refresh the voltage configuration data in response to voltage command data from the timing controller 11 to control the programmable voltage generation unit 12.

The detection circuit 16 is configured to detect the voltage configuration data or signals, corresponding to the gamma voltages, of the programmable voltage generation unit 12 to adjust the output gamma voltages. The detailed cooperation of providing the gamma voltages by the gamma voltage generation circuit 10 will be discussed in the following paragraphs.

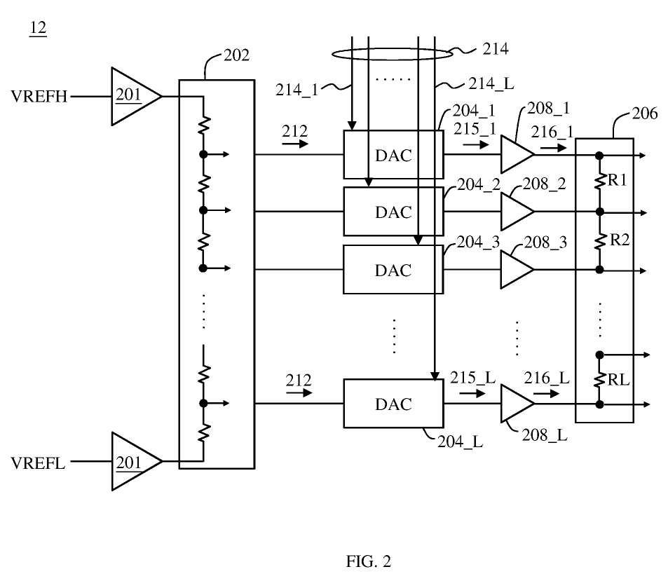

Reference is now made to FIG. 2. FIG. 2 is schematic diagram of a programmable voltage generation unit 12, in accordance with some embodiments. The programmable voltage generation unit includes multiple digital-to-analog converters (DACs) 204_1 to 204_L. The programmable voltage generation unit 12 further includes resistor strings 202 and 206 and amplifiers 208_1 to 208_L. The DACs 204_1 to 204_Lare M-bit DACs. Detailed description of the DACs 204_2 to 204_Lmay refer to related description for the DAC 204_1, and detailed description of the amplifiers 208_2 to 208_Lmay refer to related description for the amplifier 208_1 The resistor string 202 is coupled to a reference voltage terminal of the DAC 204_1, an output terminal and an input terminal of the DACs are respectively coupled to the control circuit 14 and a corresponding amplifier 208_1 and further to the resistor string 206.

Referring to FIG. 2, the resistor string 202 is used to divide input power voltages VREFH and VREFL into divided voltages 212 having, for example, 2M voltage levels and output the divided voltages 212 to the DAC 204_1. The DAC 204_1 receives a corresponding voltage configuration data 214_1 among the voltage configuration data 214_1 to 214_Lfrom the control circuit 14. According to the divided voltages 212 provided by the resistor string 202, the DAC 204_1 converts the corresponding voltage configuration data 214_1 to a voltage signal 215_1, the DAC 204_Lconverts the corresponding voltage configuration data 214_Lto a voltage signal 215_L, and so on. The amplifier 208_1 further generates output voltages 216_1 at an output terminal thereof in response to the voltage signal 215_1, the amplifier 208_Lfurther generate output voltages 216_L in response to the voltage signal 215_L, and so on. Several voltage-dividing nodes of the resistor string 206 is respectively coupled to the output terminal of one of the amplifiers 208_1 to 208_L. Output terminals of each adjacent two amplifiers are coupled with one resistor in the resistor string 206. The resistor string 206 includes several resistors, for example, R1 to RL, and divides the voltages 216_1 to 216_Loutput by the amplifiers 208_1 to 208_Las gamma voltages.

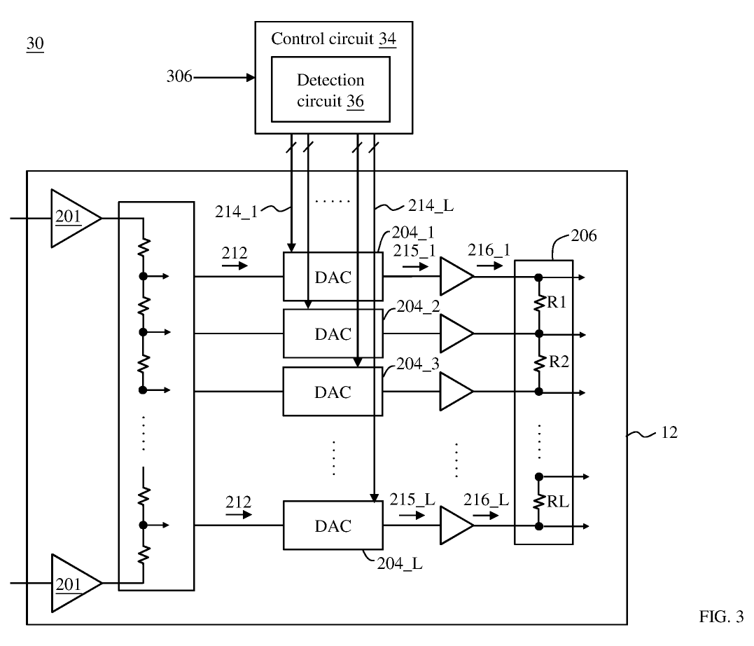

Reference is now made to FIG. 3. FIG. 3 is schematic diagram of part of a gamma voltage generation circuit 30 corresponding to FIG. 1, in accordance with some embodiments. The gamma voltage generation circuit 30 is configured with respect to, for example, the gamma voltage generation circuit 10. The control circuit 34 and the detection circuit 36 are configured with respect to, for example, the control circuit 14 and the detection circuit 16 respectively. With respect to the embodiments of FIGS. 1-2, like elements in FIG. 3 are designated with the same reference numbers for ease of understanding. The specific operations of similar elements, which are already discussed in detail in above paragraphs, are omitted herein for the sake of brevity.

As shown in the embodiments of FIG. 3, the detection circuit 36 is integrated with the control circuit 34 which provides and refreshes the voltage configuration data 214_1 to 214_Lin response to voltage command data 306 from the timing controller 11. In some embodiments, the voltage command data 306 is serial data.

In some embodiments, the detection circuit 36 is configured to verify the accuracy of the voltage command data 306 and/or the voltage configuration data 214_1 to 214_Lto be transmitted to the programmable voltage generation unit 12, thereby preventing the generation of excessive voltages that could damage the resistor string 206.

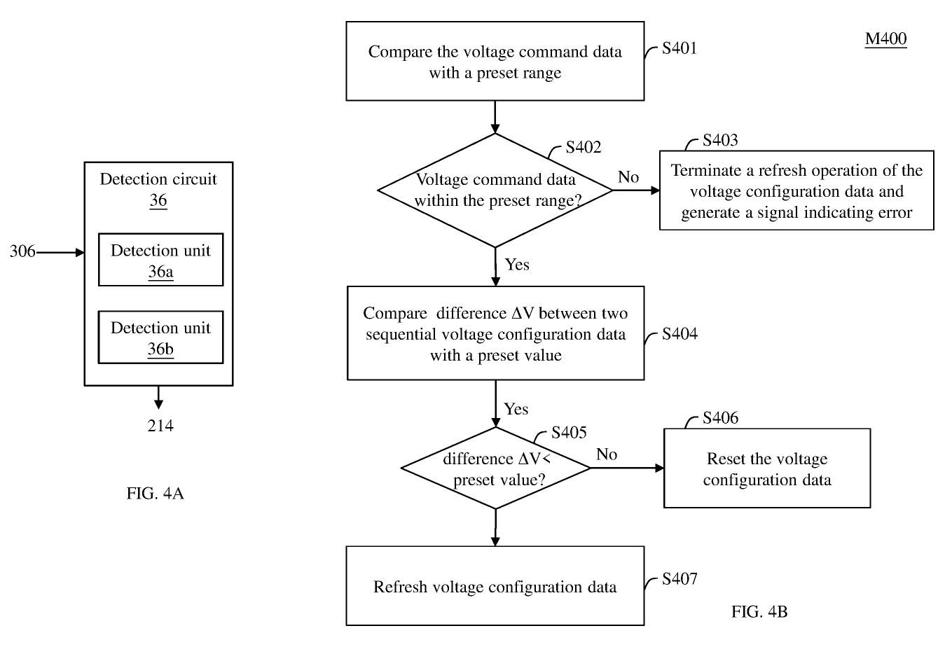

Reference is now made to FIGS. 4A-4B for instance of operations of the detection circuit 36 in the gamma voltage generation circuit 30. FIG. 4A is schematic diagram of the detection circuit 36, and FIG. 4B is a flowchart of a method M400 of operating the gamma voltage generation circuit 30 corresponding to FIG. 3 and 4A, in accordance with some embodiments.

As shown in FIG. 4A, the detection circuit 36 includes detection units 36a and 36b. In some embodiments, the detection unit 36a verifies the received voltage command data from the timing controller 11, while the detection unit 36b monitors for undesired events, such as electrostatic discharge (ESD), that could corrupt the voltage configuration data and cause the DACs to output excessive voltages.

The method M400 includes operations S401 to S407. In operation S401, the detection unit 36a compares a preset range with the voltage command data 306 received in a period of time for each DAC in the programmable voltage generation unit 12. For example, the detection unit 36a compares a first part of data in the voltage command data 306 corresponding to the DAC 204_1 with the preset range, and then further a second part of data in the voltage command data 306 corresponding to the DAC 204_2 with the preset range, and so on. The preset range corresponds to a safe operating range for the circuit design, ensuring that output voltages from the programmable voltage generation unit 12 do not damage the resistor string 206.

In operation S402, it is determined whether the voltage command data is within the preset range to perform operation S404. If the determination is operation S402 is “No,” operation S403 is performed.

In operation S403, when the voltage command data is not within the preset range, the detection unit 36a terminates a refresh operation of the voltage configuration data according to the voltage command data 306 and generates an error signal indicating an error in the voltage command data 306. In some embodiments, the control circuit 34 transmits the error signal to the timing controller 11 to request a reset of the voltage command data 306.

In operation S404, when the control circuit 34 sequentially transmits the voltage configuration data 214_1 to 214_Lto the programmable voltage generation unit 12, the detection unit 36b monitors the process and performs real-time comparison between a preset value with a difference between two sequential voltage configuration data. In some embodiments, the preset value corresponds to a safe value for every two resistors in the resistor string 206, ensuring that output voltages from the programmable voltage generation unit 12 do not damage the resistor string 206.

In operation S405, it is determined whether the difference is less than the preset value to perform operation S407. If the determination is operation S402 is “No,” operation S406 is performed.

In operation S406, when the difference is greater than the preset value, the detection circuit 36 resets the voltage configuration data of the DACs 204_1 to 204_Lin the programmable voltage generation unit 12 to a default configuration data for adjusting the output voltages 216_1 to 216_Lto a preset voltage. For example, a difference between sequential voltage configuration data 214_1 and 214_2 is “200” that is greater than the preset value “100,” the detection circuit 36 resets the voltage configuration data of the DACs 204_1 to 204_Lwith the default configuration data, for example, having a value “50.” With the configurations, the output voltages of the programmable voltage generation unit 12 are limited to a safe range.

In operation S407, the control circuit 34 refreshes the voltage configurations data in the programmable voltage generation unit 12.

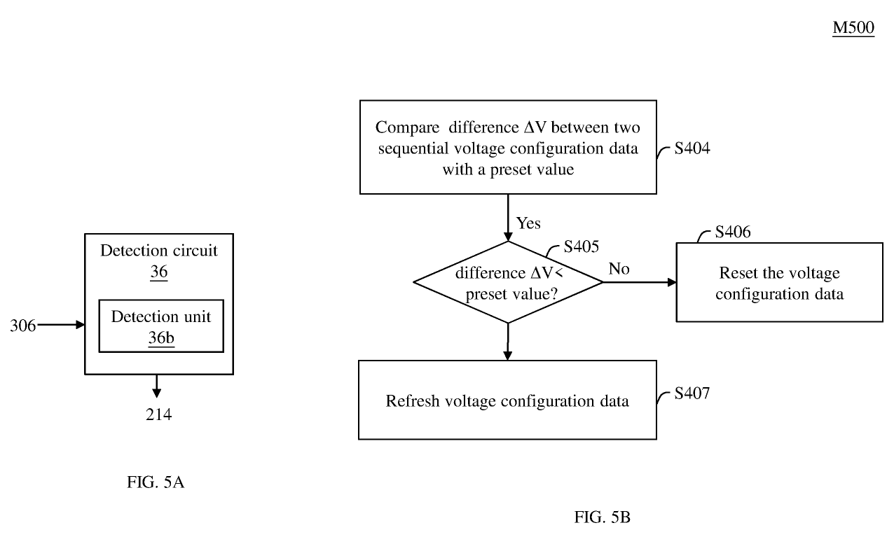

Reference is now made to FIGS. 5A-5B. Reference is now made to FIGS. 5A-5B for instance of operations of the detection circuit 36 in the gamma voltage generation circuit 30. FIG. 5A is schematic diagram of the detection circuit 36, and FIG. 5B is a flowchart of a method M500 of operating the gamma voltage generation circuit 30 corresponding to FIG. 3 and 5A, in accordance with some embodiments. In some embodiments, the method M500 includes the operations S404 to S407 recited in the method M400 of FIG. 4B.

Compared with FIG. 4A, the detection circuit 36 in the embodiments of FIG. 5A does not include the detection unit 36a and the gamma voltage generation circuit 30 performs operations S404 to S407. The repetitious descriptions are omitted here.

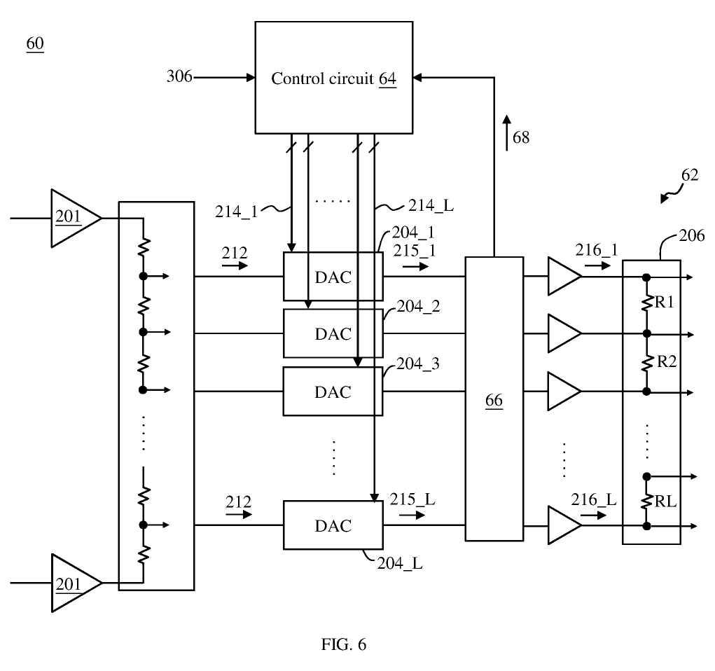

Reference is now made to FIG. 6. FIG. 6 is schematic diagram of part of the gamma voltage generation circuit 60 corresponding to FIG. 1, in accordance with some embodiments. The gamma voltage generation circuit 60 is configured with respect to, for example, the gamma voltage generation circuit 10. The control circuit 64 and the detection circuit 66 are configured with respect to, for example, the control circuit 14 and the detection circuit 16 respectively.

As shown in FIG. 6, the detection circuit 66 is coupled between the DACs 204_1 to 204_Land the amplifiers 208_1 to 208_L. In some embodiments, the detection circuit 66 detects a voltage difference between two voltage signals output from two adjacent DACs and further compares the voltage difference with a preset value to generate a signal 68 to adjust voltages received by the amplifiers 208 and further to adjust the output gamma voltages.

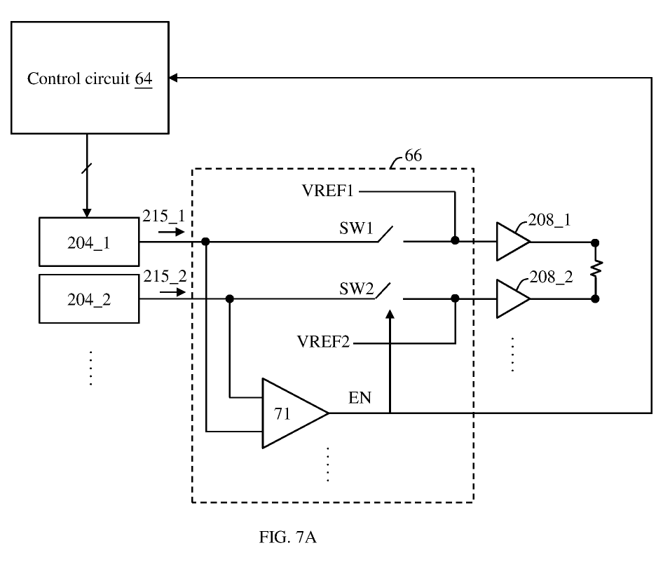

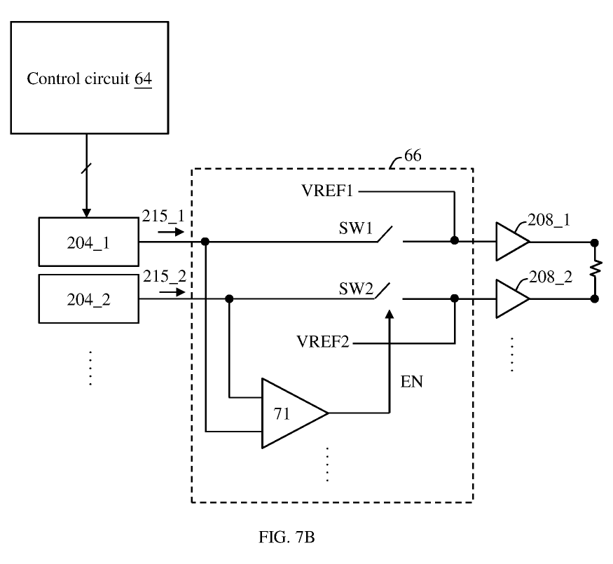

For example, reference is now made to FIG. 7A which is schematic diagram of part of the gamma voltage generation circuit 60 corresponding to FIG. 6, in accordance with some embodiments. With respect to the embodiments of FIGS. 1-6, like elements in FIGS. 7A-7B are designated with the same reference numbers for ease of understanding. As shown in FIG. 7A, the detection circuit 36 includes a number L of switches and a number (L/2) of comparators. In some embodiments, each switch is coupled between a corresponding one DAC and a corresponding amplifier. For example, the switch SW1 is coupled between the DAC 204_1 and the amplifier 208_1, the switch SW2 is coupled between the DAC 204_2 and the amplifier 208_2, and so on. One of the comparators has two inputs that are coupled to a respective DAC and another DAC. For example, a first input of the comparator 71 is coupled to the DAC 204_1 and a second input of the comparator 71 is coupled to the DAC 204_2.

In operation, for example, the comparator 71 is configured to compare two voltage signals 215_1 and 215_2 from two adjacent DACs 204_1 and 204_2 to generate an enable signal EN to selectively conduct the switches SW1 and SW2. In some embodiments, when a voltage difference between the voltage signals 215_1 and 215_2 exceeds a preset value, the switches SW1 and SW2 are turned off in response to the enable signal EN. The reference voltage VREF1 is provided to the amplifier 208_1, and the reference voltage VREF2 is provided to the amplifier 208_2. In some embodiments, the preset value is associated with a safety limit, keeping the voltage difference within a safe range and preventing excessive current between two outputs of adjacent amplifier to protect the associated resistors and circuitry coupled damage.

In addition, the detection circuit 66 further transmits the enable signal EN to the control circuit 64. The control circuit 64 resets, in response to the enable signal EN, the voltage configuration data of the DACs to a default configuration data for voltage difference within the safe range between two outputs of DACs and corresponding gamma voltages.

In some other embodiments, as shown in FIG. 7B, the detection circuit 66 is disconnected from the control circuit 64 to instruct a reset operation.

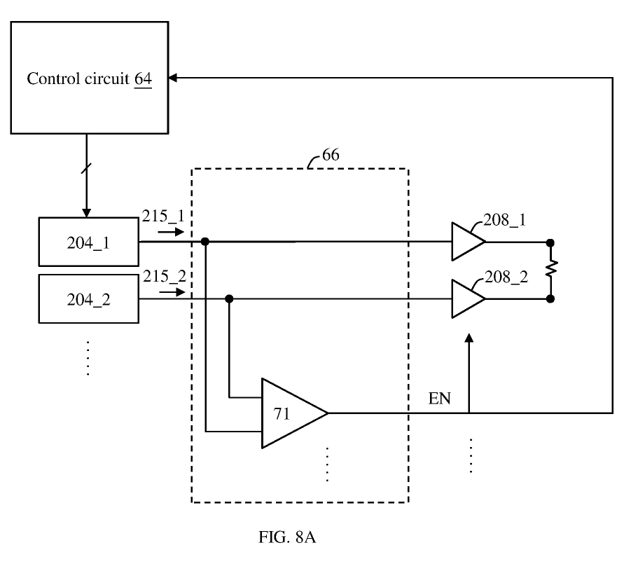

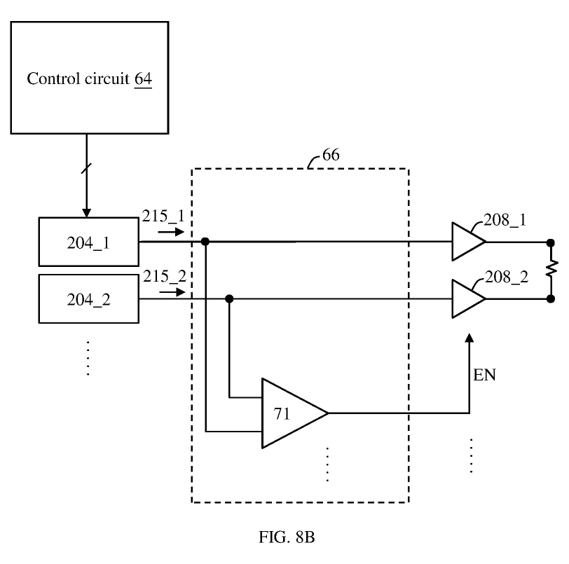

Reference is now made to FIGS. 8A-8B. FIGS. 8A-8B are schematic diagrams of part of the gamma voltage generation circuit 60 corresponding to FIG. 6, in accordance with some embodiments. With respect to the embodiments of FIGS. 1-7B, like elements in FIGS. 8A-8B are designated with the same reference numbers for ease of understanding.

Compared with the embodiments of FIG. 7A, instead of selectively providing proper signals for the amplifiers, the comparators in FIG. 8A, for example, 71, generate the enable signal EN to turn off corresponding amplifiers (e.g., 208_1 to 208_2) when the voltage difference between the voltage signals 215_1 to 215_2 exceeds the preset value, which blocks conductive paths for huge currents in the resistor string 206.

Moreover, the control circuit 64 resets, in response to the enable signal EN, the voltage configuration data of the DACs to a default configuration data for voltage difference within the safe range between two outputs of DACs and corresponding gamma voltages.

In some other embodiments, as shown in FIG. 8B, the detection circuit 66 is disconnected from the control circuit 64 to instruct a reset operation.

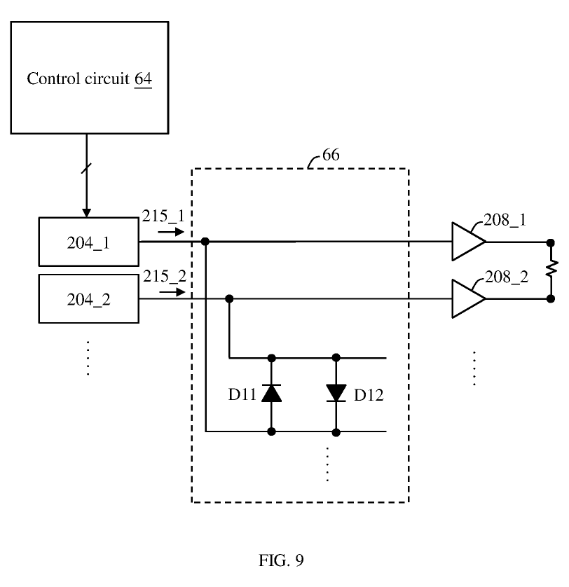

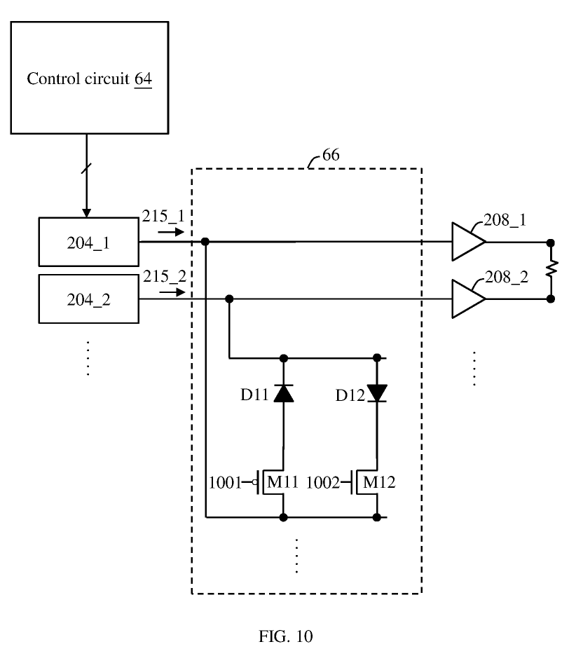

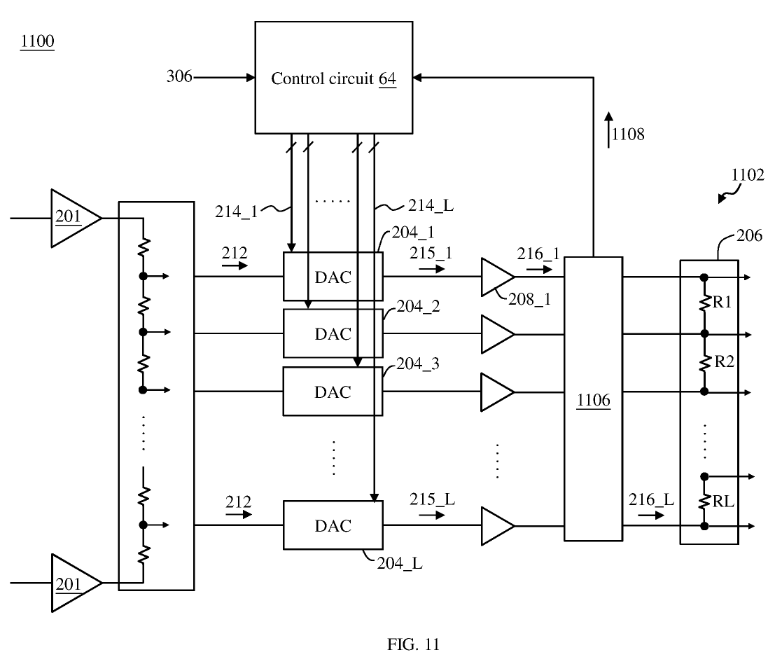

Reference is now made to FIGS. 9-10. FIGS. 9-10 are schematic diagrams of part of the gamma voltage generation circuit 60 corresponding to FIG. 6, in accordance with some embodiments. With respect to the embodiments of FIGS. 1-8B, like elements in FIGS. 9-10 are designated with the same reference numbers for ease of understanding.

In some embodiments, the detection circuit 66 is configured to receive the voltage signals from the DACs and restrict the voltage difference therebetween in a range, which protects the associated circuitry coupled damage without resetting DACs. As shown in FIG. 9, the detection circuit 66 includes two groups of diodes to form pairs of diodes, in which each pair is coupled to adjacent two DACs. In some embodiments, each of the diodes in the first group has an anode coupled to a first DAC in the two adjacent DACs and a cathode coupled to a second DAC in the two adjacent DACs. Each of the diodes in the second group has an anode coupled to the second DAC and a cathode coupled to the first DAC.

For example, the diodes D11 and D12 form a clamping unit and are coupled between outputs of the DACs 204_1 and 204_2 to clamp a voltage between two voltage signals 215_1 and 215_2 to be smaller than a preset voltage difference, for example, a threshold voltage of the diodes.

In the embodiments of FIG. 10, the preset voltage difference is adjustable by manipulating conductivity of transistors coupled to the diodes. Specifically, as shown in FIG. 10, the detection circuit 66 further includes groups of transistors, in which each in a first group is coupled in series with a corresponding one of the first group of diodes and each in a second group is coupled in series with a corresponding one of the second group of diodes. For example, the transistor M11 is coupled with the diode D11 and the transistor M12 is coupled with diode D12.

In some embodiments, the transistors in the first group and those in the second group are of different conductivity types. For example, the transistors in the first group are P-type transistors, and the transistors in the second group are N-type transistors. In another embodiment, the transistors in the detection circuit 66 are of a same type.

In the embodiments of operations, for example, the transistors M11 and M12 are configured to partially turn on or fully turn on in response to the control signals 1001 and 1002 respectively to adjust the preset voltage difference.

Reference is now made to FIG. FIG. 11 is schematic diagram of part of a gamma voltage generation circuit 1100 corresponding to FIG. 1, in accordance with some embodiments. In some embodiments, the gamma voltage generation circuit 1100 is configured with respect to, for example, the gamma voltage generation circuit 10. The detection circuit 1106 is configured with respect to, for example, the detection circuit 16.

As shown in FIG. 11, the detection circuit 1106 is coupled between the amplifiers 208_1 to 208_L and the resistor string 206. In some embodiments, the detection circuit 1106 determines whether the output voltages 216_1 to 216_Lor corresponding output currents from the amplifiers 208_1 to 208_Lexceed design limitations, for example, the current carry capacity of the resistor string 206. Correspondingly, the detection circuit 1106 generates a signal 1108 to reset voltage configuration data or reduces the outputs of the amplifier 208 to further adjust the output gamma voltages.

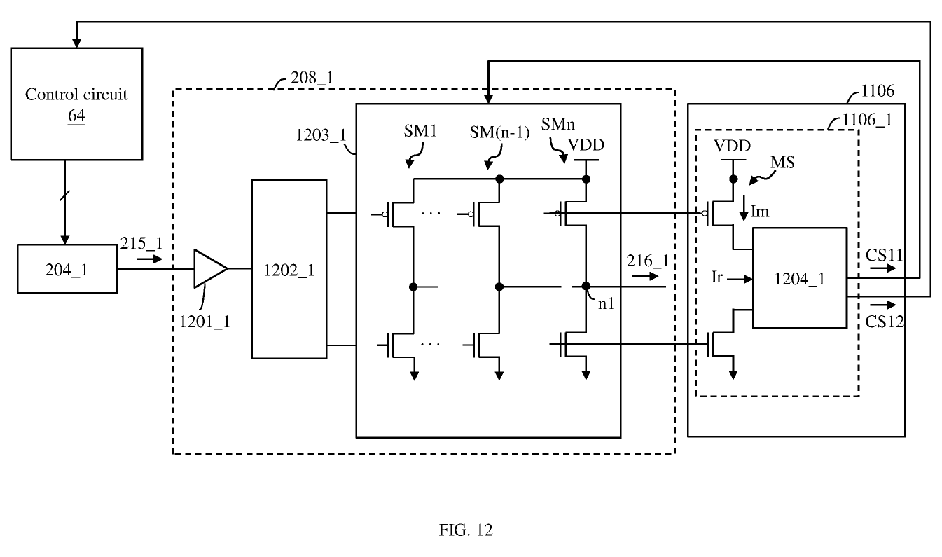

Reference is now made to FIG. 12. FIG. 12 is schematic diagram of part of the gamma voltage generation circuit 1100 corresponding to FIG. 11, in accordance with some embodiments. In some embodiments, each of the amplifiers in the gamma voltage generation circuit 1100 of FIG. 11 is coupled between a corresponding DAC, for example, 204_1 in FIG. 12 and a corresponding one, for example, 1106_1, in the comparison units 1106_1 to 1106_Lin the detection circuit 1106.

Taking the amplifier 208_1 as example, the amplifier 208_1 includes an input stage circuit 1201_1 coupled with a transition stage circuit 1202_1 and an output stage circuit 1203_1. In some embodiments, the input stage circuit 1201_1 is configured to match impedance, provides initial gain, and minimizes noise based on the input signal, for example, the voltage signal 215_1. The transition stage circuit 1202_1 provides significant amplification and impedance transformation. The output stage circuit 1203_1 delivers sufficient power and outputs the voltage, for example, 216_1, as shown in FIG. 12.

Specifically, the output stage circuit 1203_1 includes a number n of series of transistors SM1 to SMn that are coupled in parallel to output the voltage 216_1 at a node n1, n being a natural nubmer.

The comparison unit 1106_1 includes a series of monitor transistors MS. As shown in FIG. 12, the series of monitor transistors MS have gate terminals that are coupled to gate terminals of the series SM1 to SMn of transistors to generate a monitor current Im associated with the voltage 216_1. In some embodiments, a ratio of the monitor current Im and the current flowing through the node n1 is 1:X, X being natural number greater than 1, for example, 100.

The comparison unit 1106_1 further includes a comparator 1204_1 configured to generate a control signal CS11 based on the monitor current Im and a reference current Ir to adjust operational configuration of the series of transistors in the output stage circuit 1203_1. In some embodiments, the reference current Ir is associated with a preset value related to a current carry capacity of the resistor string 206.

For example, according to some embodiments, when the monitor current Im is greater than the reference current Ir, the comparison unit 1106_1 generates the control signal CS11 to turn off a number k of series in the series SM1 to SMn to reduce the current output at the node n1, k being a natural number smaller than n. In another embodiments, the comparison unit 1106_1 regulates, by the control signal CS11, gate voltages of the series SM1 to SMn of transistors to limit output current of the amplifier 208_1 in a safe preset range.

Moreover, as shown in FIG. 12, the comparator 1204_1 is further configured to generate, in response to the aforementioned comparison, a control signal CS12 to the control circuit 64 for resetting the voltage configuration data of the DACs to a default configuration data when the monitor current Im is greater than the reference current Ir.

Detailed configurations of other comparison units operating with the DACs and the control circuit 64 are similar to the comparison unit 1106_1. Hence, the repetitious descriptions are omitted here.

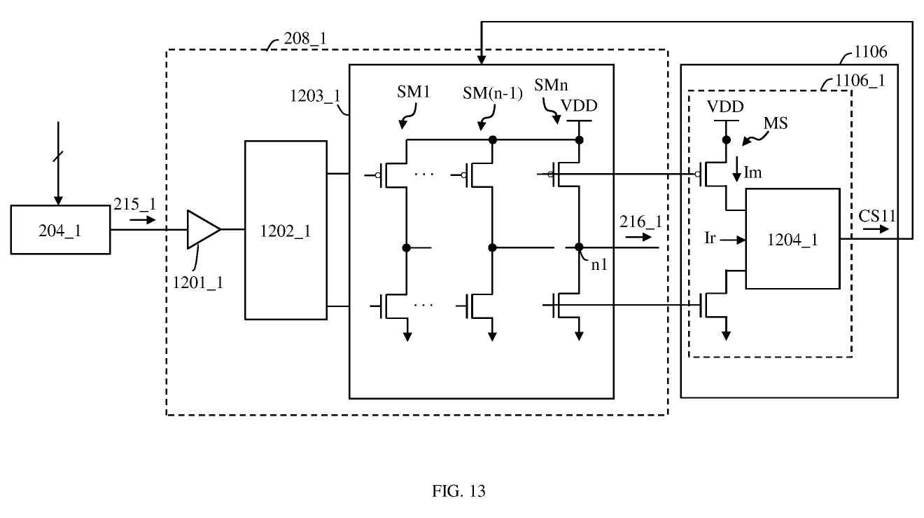

In some other embodiments, as shown in FIG. 13, the detection circuit 1106 is disconnected from the control circuit 64 to instruct a reset operation of the voltage configuration data of the DACs.

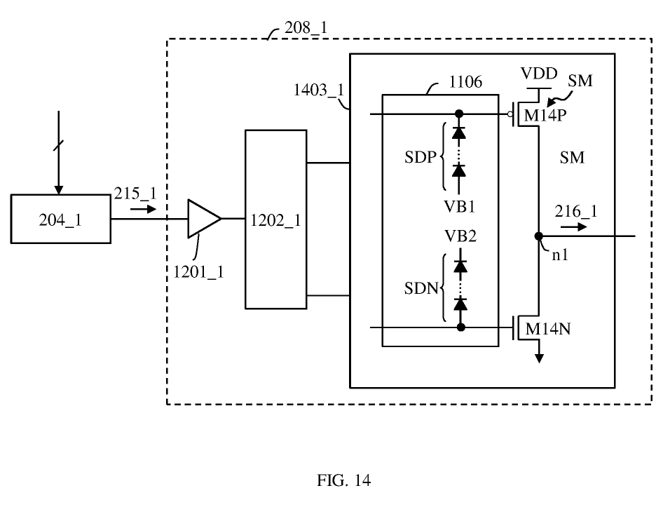

Another embodiment of restricting the output current of each amplifier utilizes control of detected gate voltages of output transistors in the amplifier. Reference is now made to FIG. 14. FIG. 14 is schematic diagram of part of the gamma voltage generation circuit 1100 corresponding to FIG. 11, in accordance with some embodiments. As shown in FIG. 14, the amplifier 208_1 includes an output stage circuit 1403_1. The output stage circuit 1403_1 includes a transistor M14P of P type and a transistor M14N of N type that are coupled in series to output the voltage 216_1 at the node n1. The detection circuit 1106 includes a series of diodes SDP coupled in series between a bias voltage VB1 and a gate terminal of the transistor M14P. The detection circuit 1106 further includes a series of diodes SDP coupled in series between a bias voltage VB2 and a gate terminal of the transistor M14N.

In operation, the gate voltage of the transistor M14P is clamped by the series of diodes SDP and has a minimum of (VB1+N*Vdiode), in which N corresponds the number of diodes in the series SDP and Vdiode corresponds a threshold voltage of the diode. Similarly, the gate voltage of the transistor M14N is clamped by the series of diodes SDN and has a maximum of (VB2+N*Vdiode), in which N corresponds the number of diodes in the series SDN and Vdiode corresponds a threshold voltage of the diode.

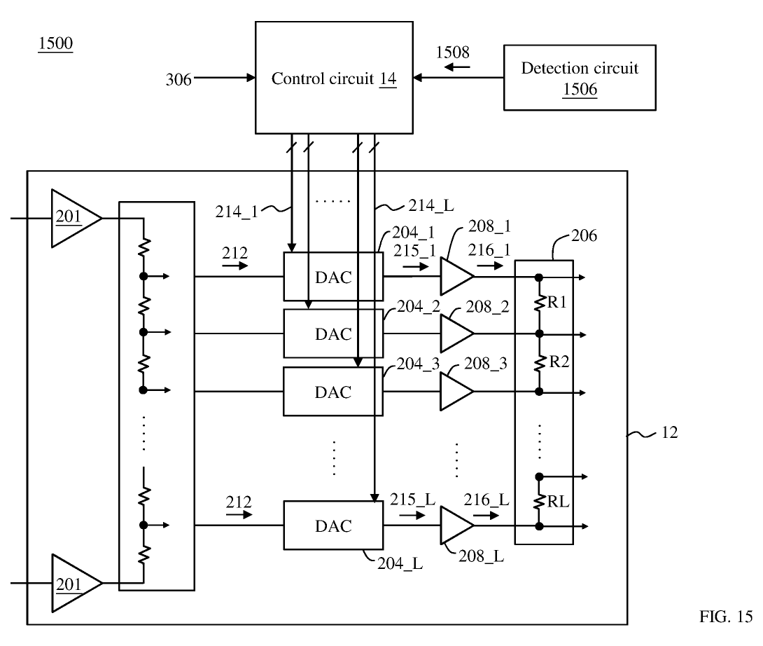

In some embodiments, the detection circuit 16 of FIG. 1 is further configured to detect characteristics, for example, temperature, of the programmable voltage generation unit 12 to generate detection data to the control circuit 14 for adjusting the gamma voltages output by the programmable voltage generation unit 12. Reference is now made to FIG. 15. FIG. 15 is schematic diagram of part of a gamma voltage generation circuit 1500 corresponding to FIG. 1, in accordance with some embodiments. With respect to the embodiments of FIGS. 1-14, like elements in FIG. 15 are designated with the same reference numbers for ease of understanding.

In the embodiments of FIG. 15, the detection circuit 1506 is arranged next to the amplifiers 208_1 to 208_L and detects an operational temperature of the programmable voltage generation unit 12. When the operational temperature is greater than a threshold temperature, the detection circuit 1506 generates the detection data 1508 indicating an initiation of a reset operation to the control circuit 14. In some embodiments, the threshold temperature corresponding to an over temperature protection temperature for the gamma voltage generation circuit 1500.

The control circuit 14 resets, in response to the detection data 1508, the voltage configuration data of the DACs 204_1 to 204_Lto a default configuration data, adjusting the output voltages 216_1 to 216_Lwithin a safe range. With the configurations of the present application, by monitoring the operational temperature, it protects the gamma voltage generation circuit 1500 from heat damage.

The configurations of FIGS. 1-15 are given for illustrative purposes. Various implements are within the contemplated scope of the present disclosure. For example, in some embodiments, the gamma voltage generation circuit can employ a combination of at least two in embodiments depicted in FIGS. 1-15.

This application discloses a driver circuit including a gamma voltage generation circuit with a protection circuit. This protection circuit prevents damage caused by incorrect voltage commands from timing controller 11 to the DACs, or by undesired events or defects in the circuitry resulting in incorrect instructions being sent to the DACs, enhancing reliability and robustness of the driver circuit. The detection circuit can be integrated with the control circuit, coupled between the DACs and the output amplifiers, or coupled between the output amplifiers and the resistor string in a programmable voltage generation unit.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A gamma voltage generation circuit, comprising:
a programmable voltage generation unit configured to generate a plurality of gamma voltages in response to voltage configuration data;
a control circuit configured to refresh the voltage configuration data in response to voltage command data to control the programmable voltage generation unit; and
a detection circuit configured to detect the voltage configuration data or voltage signals, corresponding to the plurality of gamma voltages, of the programmable voltage generation unit to adjust the plurality of gamma voltages.

2. The gamma voltage generation circuit of claim 1, wherein the detection circuit is integrated with the control circuit, and configured to:
compare a preset value with a difference between two sequential voltage configuration data; and
when the difference is greater than the preset value, reset the voltage configuration data of a plurality of digital-to-analog converters (DACs) in the programmable voltage generation unit to a default configuration data for adjusting the plurality of gamma voltages to a preset voltage.

3. The gamma voltage generation circuit of claim 2, wherein the detection circuit is further configured to:
compare the voltage command data with a preset range; and
when the voltage command data is not within the preset range, terminate a refresh operation of the voltage configuration data.

4. The gamma voltage generation circuit of claim 1, wherein the programmable voltage generation unit comprises:
a plurality of amplifiers configured to output the plurality of gamma voltages at output terminals thereof, wherein output terminals of each adjacent two of the plurality of amplifiers are coupled with a resistor; and
a plurality of digital-to-analog converters (DACs) configured to generate the voltage signals in response to the voltage configuration data;
wherein the detection circuit comprises:
a plurality of switches each coupled between a corresponding DAC in the DACs and a corresponding amplifier in the amplifiers; and
a plurality of comparators each configured to compare two voltage signals from two adjacent DACs to generate an enable signal to turn off a corresponding switch and to couple a corresponding reference voltage to the corresponding amplifier when a voltage difference between the two voltage signals exceeds a preset value.

5. The gamma voltage generation circuit of claim 4, wherein the control circuit is further configured to reset, in response to the enable signal, the voltage configuration data of the DACs to a default configuration data.

6. The gamma voltage generation circuit of claim 1, wherein the programmable voltage generation unit comprises:
a plurality of amplifiers configured to output the plurality of gamma voltages at output terminals thereof, wherein output terminals of each adjacent two of the plurality of amplifiers are coupled with a resistor; and
a plurality of digital-to-analog converters (DACs) configured to generate the voltage signals in response to the voltage configuration data;
wherein the detection circuit comprises:
a plurality of comparators each configured to compare two voltage signals from two adjacent DACs to generate an enable signal to turn off the corresponding amplifier when a voltage difference between the two voltage signals exceeds a preset value.

7. The gamma voltage generation circuit of claim 6, wherein the detection circuit is further configured to reset, in response to the enable signal, the voltage configuration data of the DACs to a default configuration data.

8. The gamma voltage generation circuit of claim 1, wherein the programmable voltage generation unit comprises:
a plurality of digital-to-analog converters (DACs) configured to generate the voltage signals in response to the voltage configuration data; and
a plurality of amplifiers each coupled to a corresponding DAC and configured to output a corresponding gamma voltage;
wherein the detection circuit comprises a plurality of diodes configured to clamp a voltage between two voltage signals from two adjacent DACs.

9. The gamma voltage generation circuit of claim 8, wherein the plurality of diodes comprises:
a plurality of first diodes each having an anode coupled to a first DAC in the two adjacent DACs and a cathode coupled to a second DAC in the two adjacent DACs; and
a plurality of second diodes each having an anode coupled to the second DAC and a cathode coupled to the first DAC.

10. The gamma voltage generation circuit of claim 9, wherein the detection circuit further comprises:
a plurality of first transistors each coupled in series with a corresponding one of the plurality of first diodes; and
a plurality of second transistors each coupled in series with a corresponding one of the plurality of second diodes.

11. The gamma voltage generation circuit of claim 10, wherein the plurality of first transistors and the plurality of second transistors are turned on in response to first control signals and second control signals.

12. The gamma voltage generation circuit of claim 10, wherein the plurality of first transistors and the plurality of second transistors are of different conductivity types.

13. The gamma voltage generation circuit of claim 1, wherein the programmable voltage generation unit comprises:
a digital-to-analog converter (DAC) configured to generate the voltage signal in response to the corresponding voltage configuration data; and
an amplifier configured to generate a first gamma voltage of the gamma voltages in response to the voltage signal and comprising:
an output stage circuit comprising a series of transistors coupled in parallel to output the first gamma voltage at a node;
wherein the detection circuit comprises:
a series of monitor transistors having gate terminals that are coupled to gate terminals of transistors in the output stage circuit to generate a monitor current associated with the first gamma voltage; and
a comparator configured to generate a first control signal based on the monitor current and a reference current to adjust operational configuration of the series of transistors in the output stage circuit.

14. The gamma voltage generation circuit of claim 13, wherein the comparator is further configured to compare the monitor current with the reference current to generate a second control signal to the control circuit for resetting the voltage configuration data of the DACs to a default configuration data when the monitor current is greater than the reference current.

15. The gamma voltage generation circuit of claim 1, wherein the programmable voltage generation unit comprises:
a digital-to-analog converter (DAC) configured to generate the voltage signal in response to the corresponding voltage configuration data; and
an amplifier configured to generate a first gamma voltage of the gamma voltages in response to the voltage signal and comprising:
an output stage circuit comprising a first transistor and a second transistor coupled in series to output the first gamma voltage at a node;
wherein the detection circuit comprises:
a first series of diodes coupled in series between a first bias voltage and a gate terminal of the first transistor; and
a second series of diodes coupled in series between a second bias voltage and a gate terminal of the second transistor.

16. The gamma voltage generation circuit of claim 15, wherein the first transistor is a P-type transistor, the second transistor is an N-type transistor.

17. A gamma voltage generation circuit, comprising:
a programmable voltage generation unit comprising a plurality of digital-to-analog converters (DACs) configured to generate signals in response to voltage configuration data, and further comprising a plurality of amplifiers each coupled to a corresponding DAC in the DACs and configured to output a corresponding gamma voltage in response to the corresponding signal;
a control circuit configured to refresh the voltage configuration data in response to voltage command data to control the programmable voltage generation unit; and
a detection circuit configured to detect characteristics of the programmable voltage generation unit to generate detection data to the control circuit for adjusting the gamma voltages.

18. The gamma voltage generation circuit of claim 17, wherein the detection circuit is arranged next to the plurality of amplifiers and detects an operational temperature of the programmable voltage generation unit,
wherein when the operational temperature is greater than a threshold temperature, the detection circuit generates the detection data indicating an initiation of a reset operation to the control circuit, and
the control circuit resets, in response to the detection data, the voltage configuration data of the DACs to a default configuration data.

19. A gamma voltage generation circuit, comprising:
a programmable voltage generation unit comprising a plurality of digital-to-analog converters (DACs) and a plurality of amplifiers, wherein an output of one of the plurality of DACs is coupled to an input of a corresponding one of the plurality of amplifiers;
a plurality of clamping units each coupled between two adjacent DACs to clamp a voltage between outputs of the two adjacent DACs; and
a control circuit configured to refresh voltage configuration data of the DACs in response to voltage command data to control the programmable voltage generation unit to output gamma voltage through the amplifiers.
